(19) United States
(12) Patent Application Publication
(10) Pub. No.: US 2003/0161139 A1
(43) Pub. Date: Aug. 28, 2003

(54) Shoulder mount for flashlight

(76) Inventor: David C. Putallaz, Rohnert Park, CA (US)

Correspondence Address: DAVID C. PUTALLAZ, 6613 MEADOW PINES AVE., ROHNERT PARK, CA, 94928, US

(21) Appl. No.: 10/081,986

(22) Filed: Feb. 25, 2002

(51) Int. Cl. F21V 21/108

(52) U.S. Cl. 362/108; 362/191; 362/396; 362/427

(57) ABSTRACT

Shoulder Mount for Flashlight with a shoulder mount assembly, a ball joint, a flashlight retaining member. The shoulder mount assembly with a rigid plate that rests on the top of the user's shoulder, the plate having an integral extension that curves downward towards the front of the user, the plate having a spring biased member that attaches to a second rigid plate that impinges on the rear shoulder portion of the user, the plate having a plurality of threaded apertures capable of retaining a threaded screw and attached thumb wheel, said plate having an integral spacer and a rigid epaulet retaining plate attached to said integral spacer, said shoulder plate having said ball joint member centrally attached to its upper surface. Said flashlight retaining member comprised of a square base plate, said square base plate having an arm at each corner, said arm rising at a ninety degree angle in side profile and rising inwardly at a roughly seventy degree angle in front profile, said arms each retaining a compression spring, said springs holding up a pair of shafts, said shafts supporting a pair of rollers, and said rollers being located above the center line of the barrel of a flashlight so that said rollers removably retain said flashlight, said flashlight base plate having a mating ball joint centrally attached to its lower surface allowing said flashlight retaining member to be angled up or down or swiveled from side to side.

### BACKGROUND OF THE INVENTION

This invention relates generally to the field of light holding devices, and more particularly to a shoulder mount for a flashlight.

Flashlights have been in existence for many years. They are portable lighting devices that usually include a battery or batteries and a bulb and reflector assembly housed within a cylindrical shaped housing.

In more recent years products have been designed and marketed that help hold flashlights in a hands free fashion so that the user can have both hands available to do activities other than holding a flashlight. Some of these designs include head mounted lights, forearm supported light as claimed in U.S. Pat. No. 6,062,447 and a shoulder supported light as claimed in U.S. Pat. No. 6,015,217.

Although this prior technology does much to address the problem of attaching a flashlight to a person so that a person has his or her hands free, there are certain deficiencies in the current designs. Firstly, the current devices do not allow a user to easily and quickly remove or replace a flashlight without looking at the operation as it is taking place. Secondly, there is no design currently available that allows for a shoulder mounted device that holds a standard flashlight and attaches to an epaulet. Thirdly, there is no current design that is shoulder mounted and allows the user to adjust the flashlight up or down or side to side. Finally, there is no current design that provides a shoulder mount for a flashlight that stabilizes the light by supporting it at the top of the shoulder as well as the front and back portion of the shoulder.

### SUMMARY OF THE INVENTION

The primary object of the invention is to provide a shoulder mount for a flashlight to allow a person to have use of the light without use of hands.

Another object of the invention is to provide a shoulder mount for a flashlight that fastens to an epaulet of a shirt or jacket.

Another object of the invention is to provide a shoulder mount for a flashlight that accepts a variety of diameters of flashlights.

A further object of the invention is to provide a shoulder mount for a flashlight that allows the user to quickly remove and replace the flashlight.

Yet another object of the invention is to provide a shoulder mount for a flashlight that allows the user to raise, lower and swivel the flashlight while in the mount.

Still yet another object of the invention is to provide a shoulder mount for a flashlight where the mounting bracket is visually unobtrusive when not flashlight is in use.

Another object of the invention is to provide a shoulder mount for a flashlight where the mount secures to the front and back portion of the shoulder portion of the user to provide greater stability for the flashlight.

Another object of the invention is to provide an alternate embodiment where the mounting attaches to the strap of a backpack or the like.

Other objects and advantages of the present invention will become apparent from the following descriptions, taken in connection with the accompanying drawings, wherein, by way of illustration and example, an embodiment of the present invention is disclosed.

Shoulder Mount for Flashlight comprising: a shoulder mount assembly, a ball joint, a flashlight retaining member, said shoulder mount assembly comprising a rigid plate that rests on the top of the user's shoulder, said plate having an integral extension that curves downward towards the front of the user, said plate having a spring biased member that attaches to a second rigid plate that impinges on the rear shoulder portion of the user, said plate having a plurality of threaded apertures capable of retaining a threaded screw and attached thumb wheel, said plate having an integral spacer and a rigid epaulet retaining plate attached to said integral spacer, said shoulder plate having said ball joint member centrally attached to its upper surface, said flashlight retaining member comprised of a square base plate, said square base plate having an arm at each corner, said arm rising at a ninety degree angle in side profile and rising inwardly at a roughly seventy degree angle in front profile, said arms each retaining a compression spring, said springs holding up a pair of shafts, said shafts supporting a pair of rollers, and said rollers being located above the center line of the barrel of a flashlight so that said rollers removably retain said flashlight, said flashlight base plate having a mating ball joint centrally attached to its lower surface allowing said flashlight retaining member to be angled up or down or swiveled from side to side.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a side view of a person wearing the shoulder mounted flashlight of the present invention.

FIG. 2 is a perspective view of a person inserting or removing a flashlight of the present invention

FIG. 3 is a perspective view of a person wearing the present invention and having the flashlight tilted downward

FIG. 4 is a front perspective view of the shoulder mounting assembly of the present invention

FIG. 5 is a rear perspective view of the shoulder mounting assembly of the present invention

FIG. 6 is an underside view of the shoulder mounting assembly of the present invention

FIG. 7 is a front view of the flashlight holding portion of the present invention

FIG. 8 is a front view of the entire shoulder mounted flashlight assembly of the present invention

FIG. 9 is a view of a person wearing an iron on epaulet of the present invention

FIG. 10 is an exploded view of an adaptor ring of the present invention

FIG. 11 is a side view of a person wearing an alternate embodiment of a strap mounted device

FIG. 12 is a front view of an alternate embodiment of the flashlight holding portion of the present invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

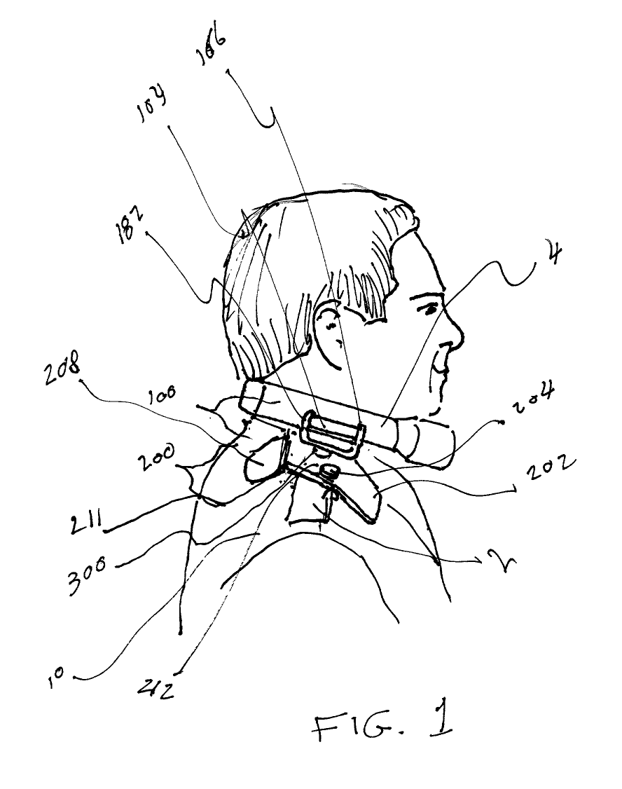

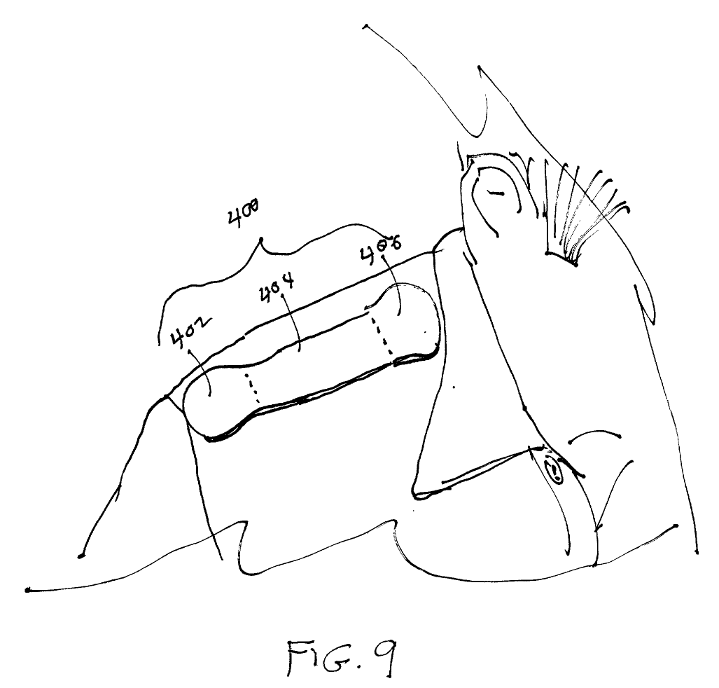

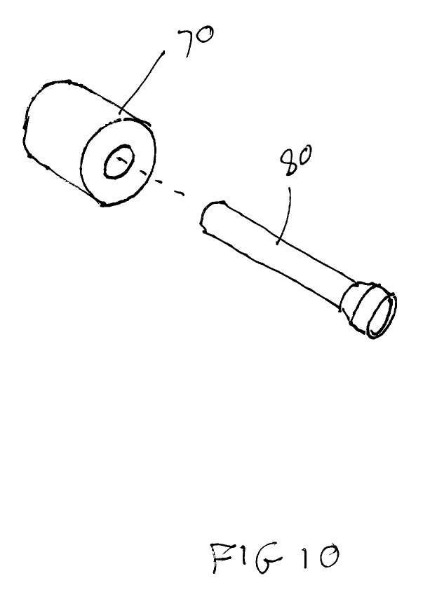

Referring now to FIG. 1 we see a person wearing the shoulder mounted flashlight holder of the present invention. The invention includes a shoulder mounting assembly portion 200, a ball joint assembly 300 and a flashlight a holding assembly portion 100. The shoulder mount assembly is removably attached to the user's shirt by means of being secured to the shirt's epaulet 2. Such epaulets can be found on the shirts and jackets of persons who work in law enforcement, emergency medical service or the like. If a person wishes to use the present invention on a shirt or jacket that does not have an epaulet 2, he or she may iron on a specially made epaulet 400 as shown in FIG. 9 where areas 402 and 406 have heat sensitive adhesive and area 404 is free to allow shoulder mounting assembly 200 to be fastened. Flashlight holding assembly 100 is attached to shoulder mount assembly 200 by ball joint 300. Shoulder assembly 200 is held to epaulet 2 by turning thumb screws 204, 206. Attachment details will be disclosed in later figures. Shoulder assembly 200 consists of a flat top plate 212 and integral downwardly curving plate 202. A torsion spring biased hinge 211 connects an inwardly biased plate 208 to flat plate 212. Ball joint assembly 300 allows the user to adjust the angle of the flashlight holding assembly 100 and allows it to swivel from side to side. The ball joint 300 is a friction fit so that after the flashlight assembly 200 is adjusted by the user, it stays in place. Flashlight holding assembly 200 holds flashlight 4 so that it can be easily inserted and removed as will be explained in future figures. The Flashlight holder assembly 200 is designed to retain the Stinger flashlight made by the Streamlight Corporation. The Stinger is the most popular light used by police and emergency workers throughout the world. However, the assembly 200 can hold other flashlights of roughly similar diameter. Additionally, flashlights having a smaller diameter can be retained by using an adaptor sleeve 70 as shown sliding onto a small diameter flashlight 80 as shown in FIG. 10.

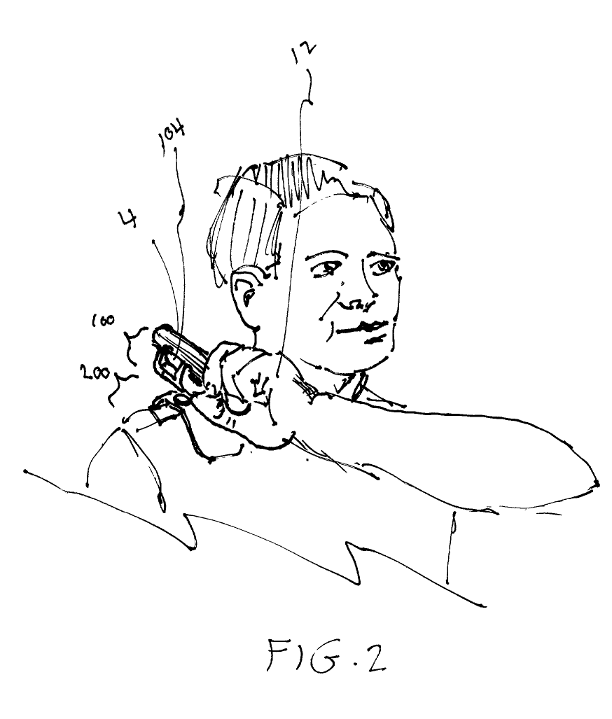

FIG. 2 shows the ease in which a user can insert or remove the flashlight 4 from the holder assembly 100. The holder design, as will be explained below, is accessible enough so that a user can insert or remove flashlight 4 without actually looking at the holder assembly 100.

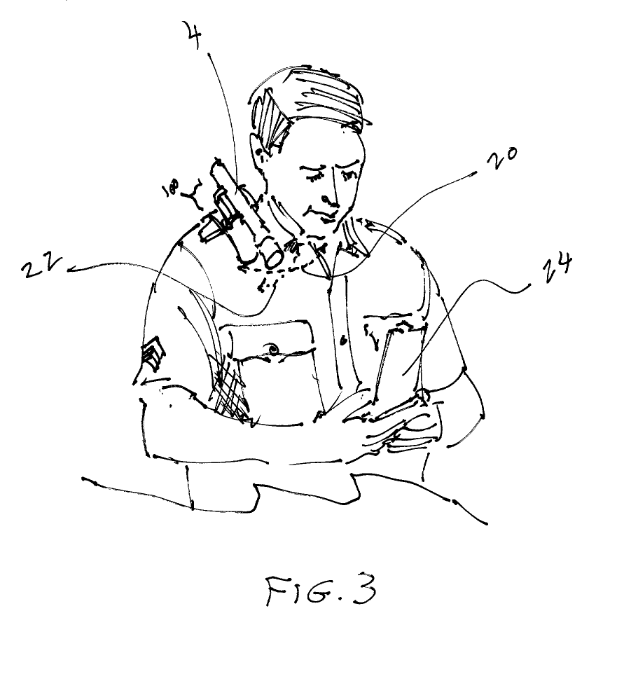

FIG. 3 shows a police officer wearing the present invention. In this situation, the officer has tilted the flashlight holding assembly 100 down so that the light emitting from flashlight 4 is aimed at ticket writing book 24. Dotted line 20 indicates swivel motion of flashlight holder 100 and dotted line 22 indicates up and down motion.

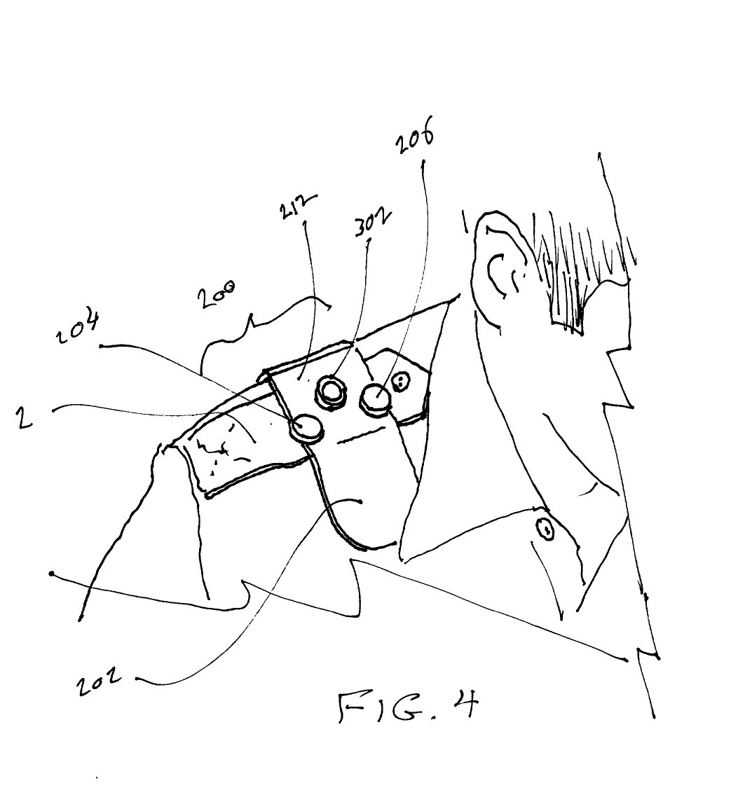

FIG. 4 shows a perspective view of the shoulder mounting portion 200. Thumb screws 204, 206 can be clearly seen to hold the shoulder mounting portion 200 onto epaulet 2. One half of the ball joint 302 can be seen as well as integral front panel 202 that helps stabilize the shoulder mount assembly 200 on the user's shoulder. It should be noted that the flashlight housing assembly 100 can be pulled off of the shoulder mount 200 by diconnecting them at the ball joint 300. In this way, a person can wear the visually unobtrusive low profile shoulder mount by itself and snap the flashlight holder 100 on when needed.

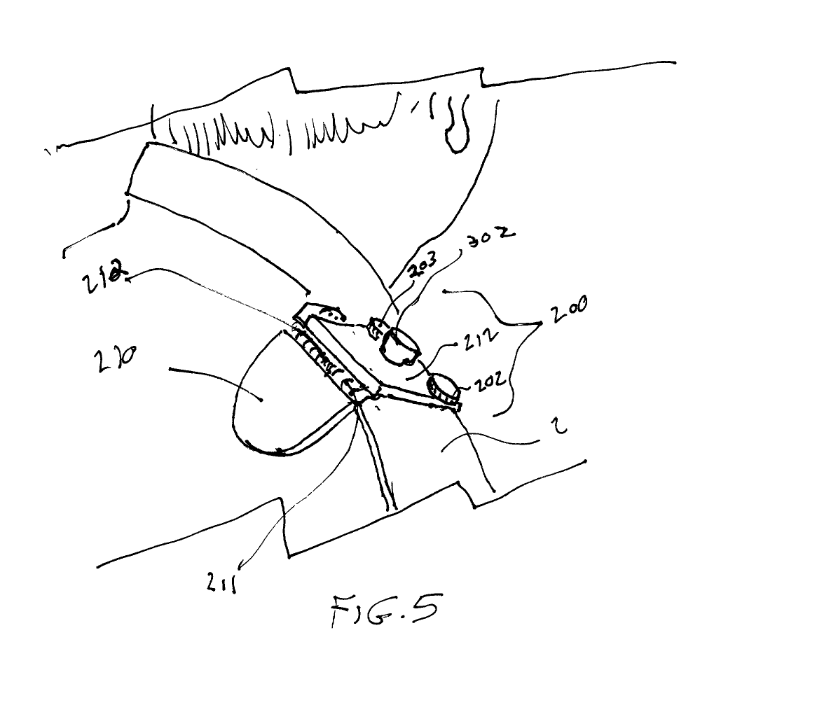

FIG. 5 shows the shoulder mount assembly 200 from the rear. This view shows clearly the hinged 211 spring biased 212 plate 210 that can automatically adjust the the size of the user's shoulder thereby creating a snug fit that insures that the flashlight holding assembly 100 and flashlight 4 will be relatively stable.

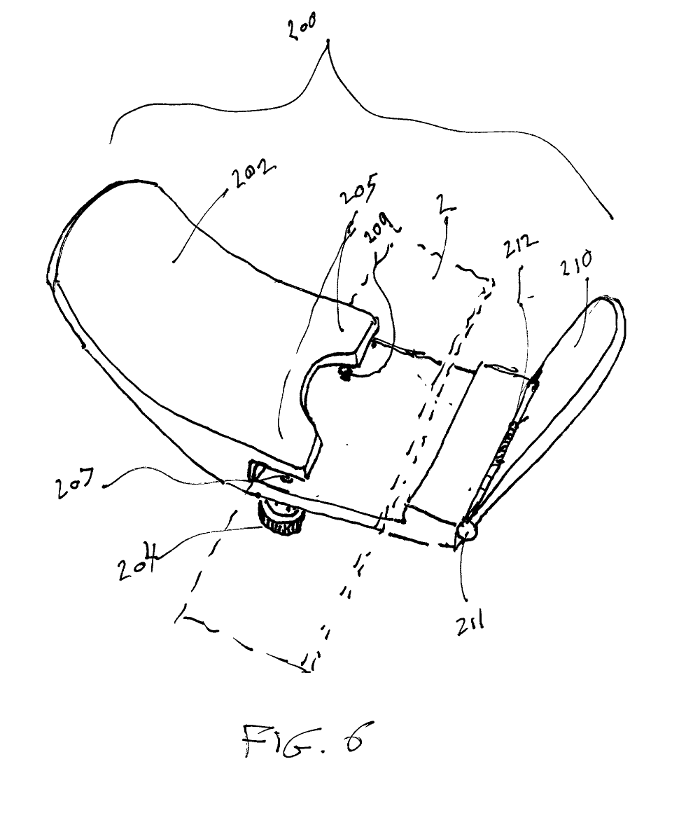

FIG. 6 shows the underside of shoulder mount 200. Epaulet, as shown by dotted line 2, is inserted under epaulet retaining plate 205 and then thumb screws 204, 206 are tightened so that screw tips 207, 209 imping on epaulet 2 thereby holding shoulder mount 200 securely in place.

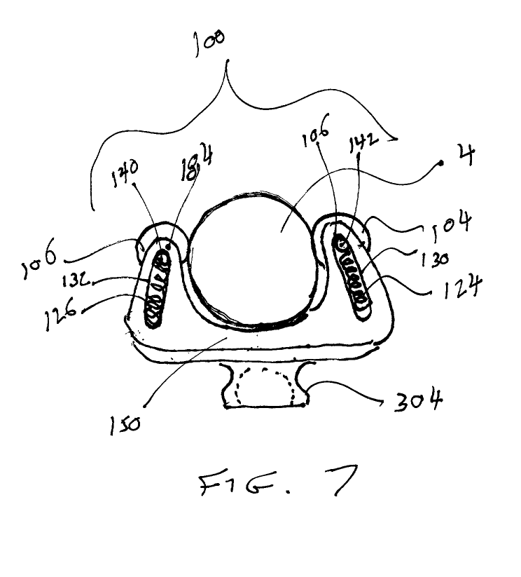

FIG. 7 shows a cut away view of flashlight holding arms 184, 106 exposing recessed portions 130, 132 that retain compression springs 124, 126 which, in turn, holds up roller shafts 140, 142. Rollers 104, 106 are slidably mounted on shafts 140, 142. When flashlight barrel 4 is inserted, the rollers 104, 106 are forced apart and then are urged inward by spring pressure as the barrel of the flashlight 4 passes beyond the apex of the diameter of the flashlight 4. In this way flashlight 4 is retained into holder assembly 100, yet can be easily removed when needed. The design of the holder 100 makes it easy for the user to snap the flashlight 4 in with one quick motion and without the need to physically look at the holder 100. Ball joint half 304 is also clearly shown.

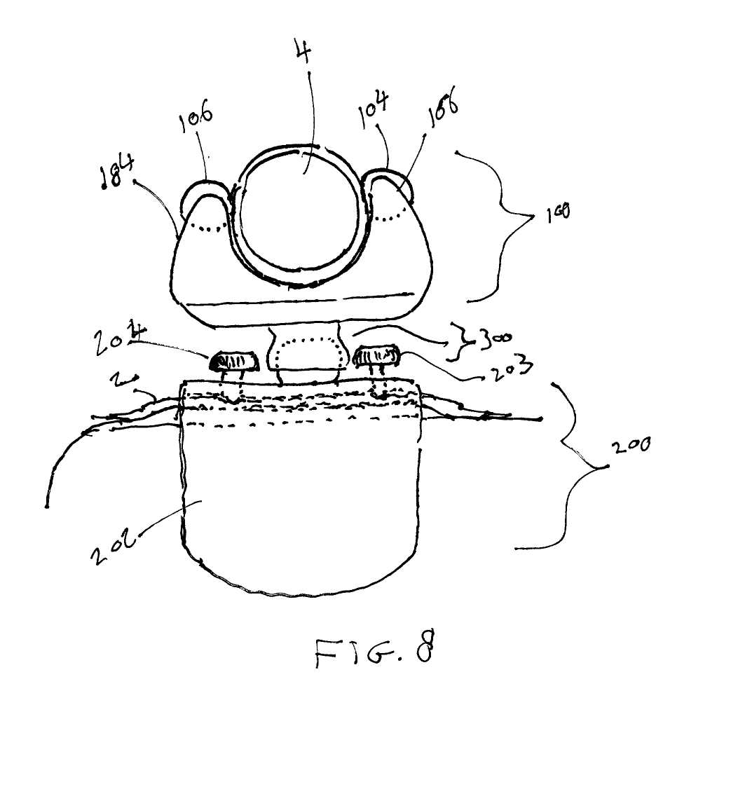

FIG. 8 shows the entire assembly of the present invention and clearly shows the relationship between shoulder assembly 200, ball joint assembly 300 and flashlight holder assembly 100. The method of attaching the shoulder assembly 200 onto epaulet 2 is also clearly seen.

FIGS. 9 and 10 have already been discussed.

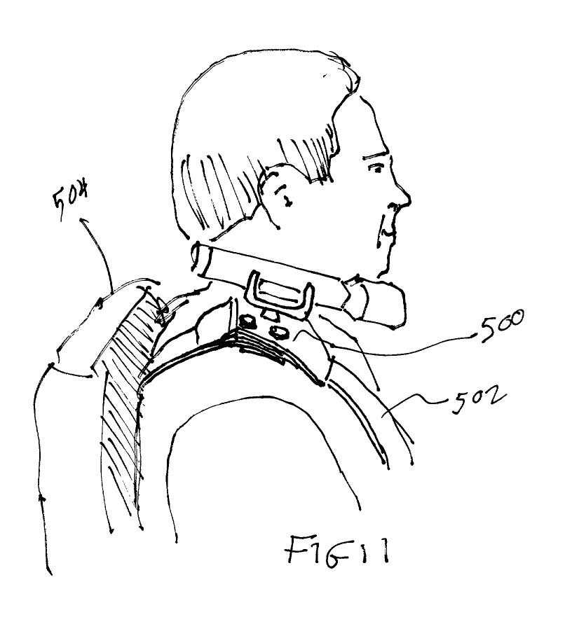

FIG. 11 shows an alternate embodiment of the present invention where the shoulder mount assembly 500 is similar the the preferred embodiment 200 except that the retaining means has been turned ninety degrees to allow it to fasten to straps 502 that are found on backpacks 504 and the like, instead of attaching to an epaulet.

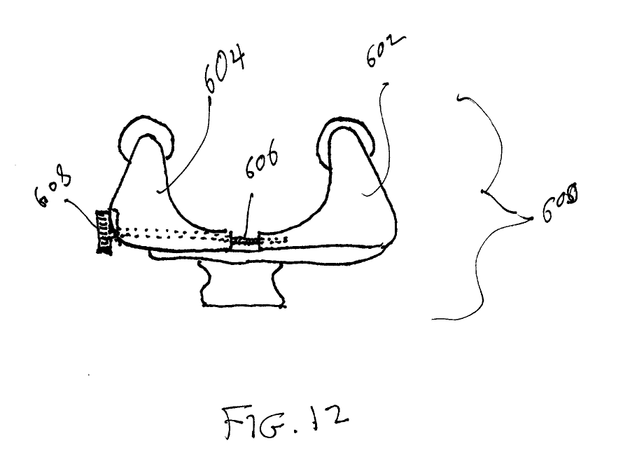

FIG. 12 shows and alternate embodiment where instead of the flashlight holder 100 of the preferred embodiment, one half of the holder 604 is separate and slidable. A threaded rod 606 and tightening knob 608 create a standard vice type action that allows movable arm 604 to move toward or away from fixed arm 602 thereby allowing different diameter flashlight barrels to be secure yet removable as described in the preferred embodiment.

The above descriptions and illustrations show that the present invention provides a unique and improved way for a person to have use of a flashlight while leaving his or her hands free for other activities. The present invention lets the user aim the flashlight as necessary and to remove or insert the flashlight quickly and without having to physically look at the action as it is taking place.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Shoulder Mount for Flashlight comprising:
a shoulder mount assembly;
a ball joint;
a flashlight retaining member;
said shoulder mount assembly comprising a rigid plate that rests on the top of the user's shoulder;
said plate having an integral extension that curves downward towards the front of the user;
said plate having a spring biased member that attaches to a second rigid plate that impinges on the rear shoulder portion of the user;
said plate having a plurality of threaded apertures capable of retaining a threaded screw and attached thumb wheel;
said plate having an integral spacer and a rigid epaulet retaining plate attached to said integral spacer;
said shoulder plate having said ball joint member centrally attached to its upper surface;
said flashlight retaining member comprised of a square base plate;
said square base plate having an arm at each corner;
said arm rising at a ninety degree angle in side profile and rising inwardly at a roughly seventy degree angle in front profile;
said arms each retaining a compression spring;
said springs holding up a pair of shafts;
said shafts supporting a pair of rollers; and
said rollers being located above the center line of the barrel of a flashlight so that said rollers removably retain said flashlight;
said flashlight base plate having a mating ball joint centrally attached to its lower surface allowing said flashlight retaining member to be angled up or down or swiveled from side to side.

2 Shoulder Mount for Flashlight as claimed in claim 1 wherein an adapter sleeve is provided that allows flashlights of smaller diameter to fit within said flashlight holding member.

3 Shoulder Mount for Flashlight as claimed in claim 1 where an alternate embodiment includes having said flashlight retaining member split and assembled into a standard vice like assembly thereby allowing flashlights of larger or smaller diameters to be employed

4 Shoulder Mount for Flashlight as claimed in claim 1 where a person can iron on a specially designed epaulet onto a shirt or the like that ordinarily has no epaulet.

5 Shoulder Mount for Flashlight as claimed in claim 1 where an alternate embodiment includes a shoulder plate having an attachment means for a strap of a backpack or scuba gear or the like.
